(19) United States
(12) Patent Application Publication
(10) Pub. No.: US 2026/0081258 A1
(43) Pub. Date: Mar. 19, 2026

(54) ENERGY STORAGE TEMPERATURE BALANCING DESIGN

(71) Applicant: VERTIV CORPORATION, Westerville, OH (US)

(72) Inventor: William M. Dixon, Lewis Center, OH (US)

(21) Appl. No.: 19/306,649

(22) Filed: Aug. 21, 2025

Related U.S. Application Data
(60) Provisional application No. 63/694,663, filed on Sep. 13, 2024.

(51) Int. Cl. H01M 10/6563; H01M 10/42; H01M 10/613; H01M 10/627

(52) U.S. Cl. CPC H01M 10/6563; H01M 10/425; H01M 10/613; H01M 10/627; H01M 2220/10

(57) ABSTRACT

A battery enclosure system and method are disclosed. The battery enclosure system may include a housing configured to enclose battery cells. The housing may include one or more baffles extending along a first direction, each baffle including a first section disposed along the first direction and a second section angled from the first section by a baffle angle. The housing may also include one or more first fans coupled to a first side wall and one or more second fans coupled to a second side wall, which is at an opposing end of the housing relative to the first side wall along the first direction. Additionally, the housing may include a set of battery cells disposed along a floor of the housing and a controller with one or more processors configured to execute a set of program instructions stored in a memory.

### CROSS-REFERENCE TO RELATED APPLICATIONS

The present application claims the benefit under 35 U.S. C. § 119(e) of U.S. Provisional Patent Application Ser. No. 63/694,663 filed Sep. 13, 2024, which is incorporated herein by reference in its entirety.

### TECHNICAL FIELD

The present disclosure generally related to the field of power distribution, and, more particularly, to maintaining battery temperatures despite temperature differentials.

### BACKGROUND

Availability of high-density AI compute systems in datacenters is causing a much-increased drive for density in the supporting power equipment adjacent to the compute hardware. It may be more difficult and costly to maintain temperatures of the power equipment in smaller volumes due to the higher power densities.

### SUMMARY

Broadly speaking, the present disclosure is directed to a battery enclosure with internal baffles and front and rear fan inlets/outlets configured to be selectively operated to dynamically control the air flow paths and temperatures inside the battery enclosure.

A battery enclosure system is disclosed in accordance with one or more illustrative embodiments of the present disclosure. In one illustrative embodiment, the battery enclosure system may include a housing configured to enclose a set of battery cells. In one illustrative embodiment, the housing may include one or more baffles extending along a first direction, each baffle including a first section disposed along the first direction and a second section coupled to the first section and angled from the first section by a baffle angle. In one illustrative embodiment, the battery enclosure system may include one or more first fans coupled to a first side wall of the housing. In one illustrative embodiment, the battery enclosure system may include one or more second fans coupled to a second side wall of the housing where the second side wall is at an opposing end of the housing relative to the first side wall along the first direction. In one illustrative embodiment, the set of battery cells may be disposed along a floor of the housing. In one illustrative embodiment, the battery enclosure system may include a controller including one or more processors coupled to the one or more first fans and the one or more second fans and configured to execute a set of program instructions stored in a memory. In one illustrative embodiment, the set of program instructions may be configured to cause the one or more processors to selectively operate at least one of the one or more first fans or the one or more second fans at a respective first fan speed or a respective second fan speed to selectively control air flow paths within the housing. In one illustrative embodiment, the air flow paths may be disposed at least one of between the one or more baffles or outside the one or more baffles.

In a further illustrative embodiment, the baffle angle may be more than 10 degrees from the first direction and more than 90 degrees as measured as an arc from the first section.

In a further illustrative embodiment, the one or more baffles may include two opposing baffles with respective baffle angles angled away from a center of the housing.

In a further illustrative embodiment, the housing may include holes on a third side wall and a fourth side wall of the housing orthogonal to the first side wall and the second side wall.

In a further illustrative embodiment, the baffle angle and the second section of each baffle may be adjustable.

In a further illustrative embodiment, the one or more second fans may be positioned in front of the second section of at least one baffle of the one or more baffles along the first direction and the one or more first fans may be placed along a central air path between two distinct baffles where the one or more baffles include two or more baffles including the two distinct baffles.

In a further illustrative embodiment, the battery enclosure system may be configured for a circulation mode configured to circulate air within the housing and thereby maintain the set of battery cells above a threshold temperature.

In a further illustrative embodiment, the battery enclosure system may further include a DC-DC converter disposed in a corridor between two of the one or more baffles where the one or more first fans and the one or more second fans are configured to cool the DC-DC converter during charging and discharging of the set of battery cells.

In a further illustrative embodiment, a first portion of the set of battery cells may be located on a first side of the corridor and a second portion of the set of battery cells may be located on a second side of the corridor opposite relative to the first side.

In a further illustrative embodiment, the set of battery cells and the DC-DC converter disposed inside a volume of the housing may be shorter than an internal height of the volume inside the housing to allow air to flow over the set of battery cells and the DC-DC converter.

A method is disclosed in accordance with one or more illustrative embodiments of the present disclosure. In one illustrative embodiment, the method may include selectively operating at least one of one or more first fans or one or more second fans at a respective first fan speed or a respective second fan speed to selectively control air flow paths within a housing of a battery enclosure system. In one illustrative embodiment, the housing may be disposed between one or more baffles or outside the one or more baffles. In one illustrative embodiment, the battery enclosure system may include the housing enclosing a set of battery cells. In one illustrative embodiment, the housing may include one or more baffles extending along a first direction. In one illustrative embodiment, each baffle may include a first section disposed along the first direction and a second section coupled to the first section and angled by a baffle angle. In one illustrative embodiment, the battery enclosure system may include one or more first fans coupled to a first side wall of the housing. In one illustrative embodiment, the battery enclosure system may include one or more second fans coupled to a second side wall of the housing where the second side wall is at an opposing end of the housing relative to the first side wall along the first direction. In one illustrative embodiment, the set of battery cells may be disposed along a floor of the housing.

In a further illustrative embodiment, the baffle angle may be more than 10 degrees from the first direction and may be more than 90 degrees as measured as an arc from the first section.

In a further illustrative embodiment, the one or more baffles may include two opposing baffles with respective baffle angles angled away from a center of the housing.

In a further illustrative embodiment, the battery enclosure system may include holes on a third side wall and a fourth side wall of the housing orthogonal to the first side wall and the second side wall.

In a further illustrative embodiment, the method may include adjusting the baffle angle and the second section of at least one baffle of the one or more baffles.

In a further illustrative embodiment, the one or more second fans may be positioned in front of the second section of the one or more baffles along the first direction and the one or more first fans may be placed along a central air path between two distinct baffles where the one or more baffles include two or more baffles including the two distinct baffles.

In a further illustrative embodiment, the battery enclosure system may be configured for a circulation mode to circulate air within the housing and thereby maintain the set of battery cells above a threshold temperature.

In a further illustrative embodiment, the method may include a DC-DC converter disposed in a corridor between two of the one or more baffles where the one or more first fans and the one or more second fans are configured to cool the DC-DC converter during charging and discharging of the set of battery cells.

In a further illustrative embodiment, a first portion of the set of battery cells may be located on a first side of the corridor and a second portion of the set of battery cells may be located on a second side of the corridor opposite the first side.

In a further illustrative embodiment, the set of battery cells and the DC-DC converter disposed inside a volume of the housing may be shorter than an internal height of the volume inside the housing to allow air to flow over the set of battery cells and the DC-DC converter.

It is to be understood that both the foregoing general description and the following detailed description are exemplary and explanatory only and are not necessarily restrictive of the invention as claimed. Also, it is to be understood that the phraseology and terminology used herein is for the purpose of description and should not be regarded as limiting. The accompanying drawings, which are incorporated in and constitute a part of the specification, illustrate embodiments of the invention, and, together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 is a top view of the battery enclosure system, in accordance with one or more embodiments of the present disclosure.

FIG. 2 is a front view of a first side wall of the battery enclosure system, in accordance with one or more embodiments of the present disclosure.

FIG. 3 is a white space of a server room including hot aisles and cold aisles, in accordance with one or more embodiments of the present disclosure.

FIG. 4A is a top view of the battery enclosure system with side air flows toward the first direction and second fans directing air toward the first direction, in accordance with one or more embodiments of the present disclosure.

FIG. 4B is a front view of the battery enclosure system with side air flows toward the first direction and second fans directing air toward the first direction, in accordance with one or more embodiments of the present disclosure.

FIG. 5 is a top view of the battery enclosure system with side air flows toward the first direction and second fans directing air away from the first direction, as well as central air flow away from the first direction, in accordance with one or more embodiments of the present disclosure.

### DETAILED DESCRIPTION

Reference will now be made in detail to the subject matter disclosed, which is illustrated in the accompanying drawings.

Batteries are typically best kept in a relatively narrow temperature range for performance and life purposes. Placing a battery enclosure in the white space (an area of a datacenter that houses IT equipment and infrastructure, such as servers, storage, racks, and power distribution systems) presents a new challenge due to the temperature and pressure difference between the cold aisle with exemplary temperature range of less than 25 degrees Celsius (front) and hot aisle with exemplary temperature range of greater than 50 degrees Celsius (rear), which may (without the benefits of the present disclosure) result in a large temperature difference in individual battery cells across the geometry of the enclosure. Further complicating the problem is that batteries positioned in a white space may share an enclosure with a power converter, which produces significant heat and typically requires its own airflow. An additional complication is that batteries may be expected to give full rated backup time even if the customer's external HVAC equipment has failed, and the ambient temperature of the “cold”side may be very low or very high.

Broadly speaking, the present disclosure is directed to a battery enclosure with internal baffles and front and rear fan inlets/outlets configured to be selectively operated to dynamically control the air flow paths and temperatures inside the battery enclosure. At least some embodiments of the present disclosure include an ultra-high-power density battery shelf configured to be placed in an IT rack on the datacenter floor (“white space”), near artificial intelligence (AI) compute systems.

The selective operation of the fans combined with the baffles inside the enclosure may allow for directing the air flow along a middle/central path or on outer paths on either side of the central path. Further, this may be used in conjunction with sensed temperatures (e.g., via temperature sensors) of these paths and external air to selectively control whether warm or cool air is distributed over the battery cells within the enclosure. In this way, the temperature of the battery cells may be optimally controlled through select operation of the front and rear fans. In particular, select fan speed differences, ratios, and directions of the front and rear fans may be used to selectively direct air down the two or more air flow paths within the enclosure. The battery enclosure may allow for a system that is highly efficient and effective at maintaining the health of the batteries in datacenter floor white space, which may be prone to large temperature differentials. In at least some embodiments, the battery enclosure may be configured to be operable even if the user's external white space HVAC equipment has failed, wherein the fans provide a backup and a supplemental way to keep the batteries at operating temperatures.

In at least some embodiments, the enclosure maintains the individual battery cells in a narrow temperature range despite large differences in temperature and pressure on different sides of the enclosure, and avoids extra components—and their associated size and cost—which would otherwise be placed in the design specifically for this task.

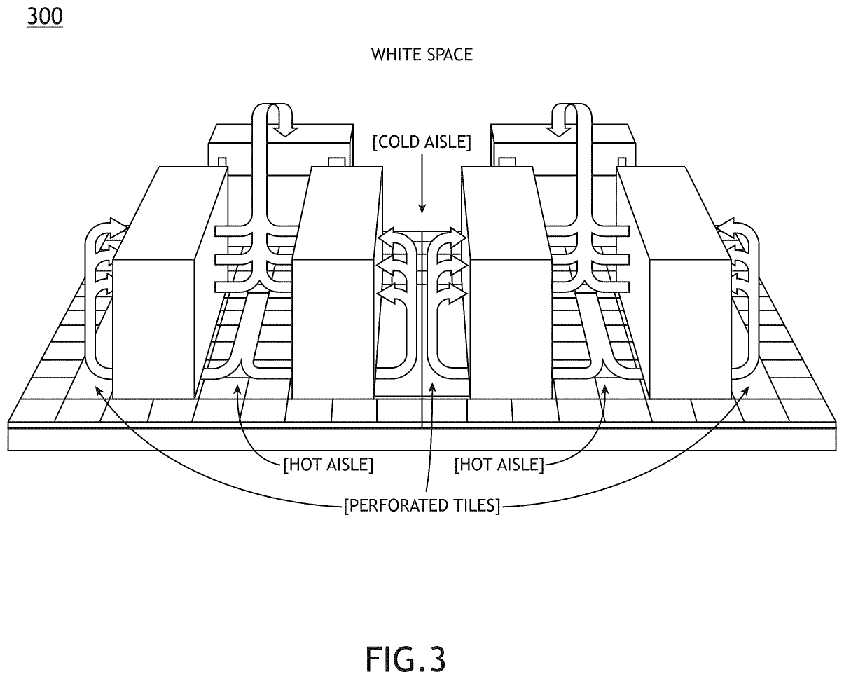

When downstream server racks are operational, the hot aisle between the server racks may typically be between 50-70° C. and have a pressure that is 0.2″ H₂O above a pressure of the cold aisle. Battery backup time may need to be configured to be maintained across very wide cold aisle temperature ranges, such as cold aisle temperatures between −5° C. to 45° C. See FIG. 3 for an example layout of hot aisles and cold aisles of a white space 300.

Battery backup time, power, and size requirements may be very aggressive, and a design cannot necessarily simply oversize batteries to compensate for wide temperature ranges. Batteries may need to be configured to stay in a temperature range of 15-45° C. It may be desirable to maintain a difference between a temperature of a front portion and a temperature of a rear portion of the batteries to be within 3° C. of each other.

Counterintuitively, it may not be necessary to blow air over cells during discharge or recharge of the batteries. Even though such use of the batteries may raise the temperature of the batteries, blowing air over the batteries at such a time may tend to cause large front-to-back temperature changes.

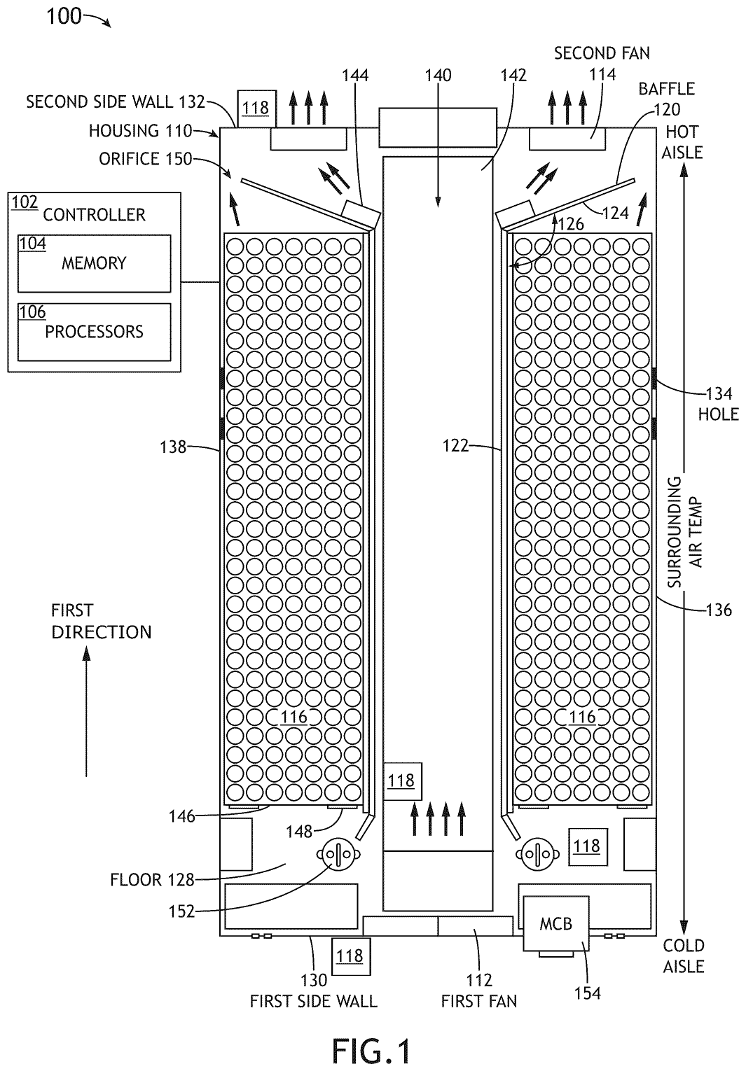

FIGS. 1-5 illustrate an example of a battery enclosure system 100, in accordance with one or more embodiments.

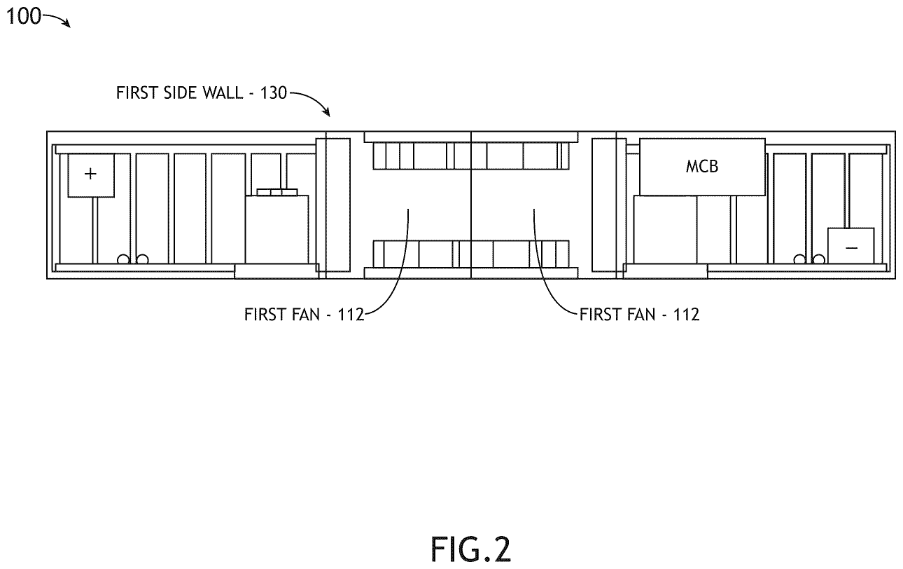

FIG. 1 illustrates a top view of the battery enclosure system 100, in accordance with one or more embodiments of the present disclosure. FIG. 2 illustrates a front view of a first side wall 130 of the battery enclosure system 100, in accordance with one or more embodiments of the present disclosure.

In embodiments, the battery enclosure system 100 includes a housing 110 configured to enclose a set of battery cells 116.

In embodiments, the housing 110 includes one or more baffles 120 extending along a first direction. Each baffle 120 may include a first section 122 disposed along the first direction and at least a second section 124 coupled to the first section 122 and angled from the first section 122 by a baffle angle 126. For example, the first section 122 may separate a corridor 140 from the batteries 116. The second section 124 may be angled off to a side to advantageously control airflow. For example, the baffles 120 may allow for selectively cooling and/or heating the batteries 116 and/or the converter 142 (e.g., DC-DC converter).

The converter 142 may generate substantial heat, the external hot and cold aisles may vary in temperature relative to desired temperatures for the components in the housing 110, and the batteries may need to be at specific temperatures at specific times (e.g., for storage, charging, or discharging). The baffles may provide advantageous air flow pathways over the converter 142 and the batteries 116 that may reduce the number of discrete components used in other designs. For example, the number of fans may be reduced, saving costs. For example, instead of having three groups of fans, one over the left side batteries 116, one over the central converter 142, and one over the right side batteries 116, it is contemplated that a single set of fans on each side of the housing 110 may be enough to control air flow in the desired speed and direction over the center versus the side pathways.

The housing 110 may include one or more first fans 112 coupled to a first side wall 130 of the housing 110 and one or more second fans 114 coupled to a second side wall 132 of the housing 110. The second side wall 132 may be at an opposing end of the housing 110 relative to the first side wall 130 along the first direction.

The set of battery cells 116 may be disposed along a floor 128 of the housing 110. For example, a first portion of the set of battery cells 116 may be located on a first side of the corridor 140 and a second portion of the set of battery cells 116 may be located on a second side of the corridor 140 opposite relative to the first side.

The battery enclosure system 100 may include a controller 102. The controller 102 may include one or more processors 106. The controller 102 may be coupled to the one or more first fans 112 and the one or more second fans 114. The controller 102 may be configured to receive sensed temperatures (e.g., via temperature sensors 118) of these paths and external air to selectively control whether warm or cool air is distributed over the battery cells within the enclosure. For example, a sensed temperature above a select threshold may be configured to trigger at least one of the one or more first fans 112 or the one or more second fans 114. For example, a sensed temperature below a select threshold may be configured to trigger at least one of the one or more first fans 112 or the one or more second fans 114 The one or more processors 106 may be configured to execute a set of program instructions stored in a memory 104. The set of program instructions may be configured to cause the one or more processors 106 to selectively operate at least one of the one or more first fans 112 or the one or more second fans 114 at least one of a respective first fan speed or a respective second fan speed to selectively control air flow paths within the housing 110. The housing 110 may be disposed at least one of between the one or more baffles 120 or outside the one or more baffles 120.

With all fans 112, 114 off, it may be that the battery enclosure system 100 is configured to direct warm air (e.g., approximately 15-25° C. warmer than the cold/front side) to be forced into the rear (e.g., top of FIG. 1) of the battery enclosure system 100 due to pressure differences caused by the hot aisle versus the cold aisle outside the battery enclosure system 100. This pressure may be referred to as “back pressure.”

In some embodiments, the first fans 112 (e.g., front fans, cold aisle fans) are configured to turn on to force cool air from the cold/front side into the enclosure. The first fans 112 may be positioned to push air into a specific path; in FIG. 1 this path is a central “corridor” path of a corridor 140. For example, this corridor 140 may include a DC-DC converter 142 as shown. In this way, the first fans 112 may be configured to be aligned centrally to direct air over a DC-DC converter 142.

The paths may include this central path and side paths near third and fourth side walls 136, 138 on either side of the baffles 120, wherein the baffles 120 define each side of the central path over the corridor 140.

In embodiments, air gaps may be included above the components (e.g., cells, converters 142, etc.) to allow air flow in these paths. In other words, such components may be shorter than the internal height of the volume inside the housing 110 to allow air to flow over the components.

In some embodiments, the second fans 114 (e.g., rear fans, hot aisle fans) may be configured to turn on to induce cool air into or out of the enclosure from the front.

In embodiments, the airflow path may be changed depending on whether the second fans 114 are on or off, what their absolute speed is, and also by the relative speed relative to the speed of the first fans 112. In this way, by controlling the absolute and relative speeds and directions of the fans 112, 114, the fans may be used to selectively control which air flows over whichever air flow paths (e.g., central path, side paths) are desired.

For example, depending on a speed of the first fans 112 and second fans 114 (e.g., 0-100% speed range), warm air from the second fan 114 may be permitted to travel into the battery enclosure system 100 to warm the battery cells 116, or cool air may be configured to be drawn over the battery cells 116.

In some embodiments, the fans may be operated in reverse (i.e., away from the first direction) to support any suitable air flow path.

In some embodiments, the baffles 120 (e.g., air baffles) themselves may be configured to be adjustable to modify the quantity of warm or cool air which reaches the battery cells 116 in different fan operation speeds. For example, the baffles 120 may be adjusted during the product design stage to have any permanent shape for a variety of operational schemes. By way of another example, the baffles 120 may be configured to be adjustable in real-time via an actuator 144 (e.g., where the baffle includes adjustable slatted blades of a louver design) to dynamically change the baffle shape/angle 126 during operation via the controller 102. For instance, there may be a hinge coupled between the first section 122 and the second section 124. By way of another instance, the louvers of the baffle 120 wall may be configured to selectively restrict an amount of airflow. The actuator 144 may be coupled to the controller 102.

In some embodiments, additional holes 134 may be included in the side walls 136, 138 of the enclosure to change the pattern of air movement to achieve the objective of keeping the batteries 116 at a consistent temperature.

The baffle angle 126 may be more than 10 degrees (e.g., non-parallel) from the first direction and more than 90 degrees as measured as an arc from the first section 122. In other words, the baffle angle may be between 90 and 170 degrees when measured as shown in FIG. 1 relative to an outward-facing surface of the first section 122 that faces away from the corridor 140.

The one or more baffles 120 may include two opposing baffles (e.g., distinct baffles) with respective baffle angles 126 angled away from a center of the housing 110.

The second fans 114 may be positioned in front of the second section 124 of the one or more baffles 120 along the first direction. The first fans 112 may be placed along a central air path between the two baffles 120 of the one or more baffles 120.

In at least some embodiments, during charging and discharging when the converter 142 may be in use, the first and second fans 112, 114 are configured to cool the corridor 140. For example, specifically, the first and second fans 112, 114 may be configured to cool the converter 142 along the center air flow path.

The housing 110 may include holes 134 on a third side wall 136 and a fourth side wall 138 of the housing 110 orthogonal to the first side wall 130 and the second side wall 132. The holes 134 may change a pattern of air flow movement to keep the batteries at a consistent temperature.

Benefits of the present disclosure, for at least some embodiments, are that battery cells 116 don't necessarily experience (or need) significant cool airflow as part of the design.

In some embodiments, the housing 110 includes fire insulation material 146 below the battery cells 116. In some embodiments, the housing 110 includes heating elements 148 in front of the battery cells 116 and configured to heat area near the battery cells 116. In some embodiments, the housing 110 includes a DC contactor 152 on each side of the housing 110 and at least one Miniature Circuit Breaker (MCB) 154. The MCB 154 may be located near a first fan 112 and may be configured to electrically protect one or more components.

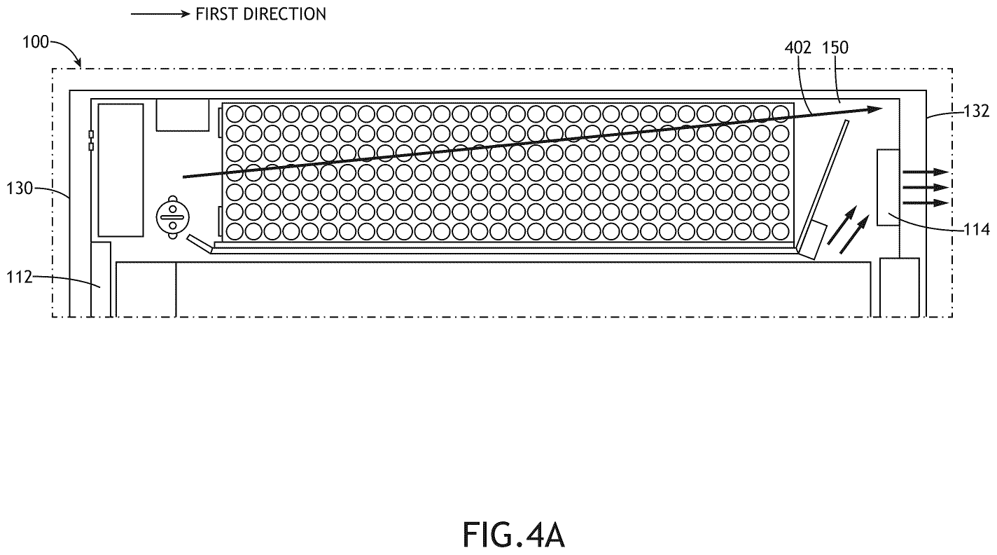

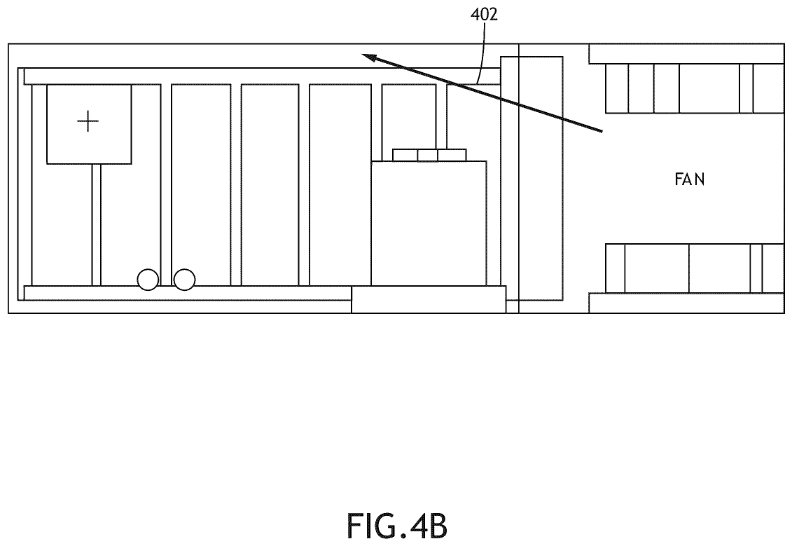

FIG. 4A illustrates a top view of the battery enclosure system 100 with side air flows 402 above the batteries 116 toward the first direction and second fans also directing air toward the first direction, in accordance with one or more embodiments of the present disclosure. FIG. 4B illustrates a front view of the battery enclosure system 100 with side air flows 402 toward the first direction and second fans directing air toward the first direction, in accordance with one or more embodiments of the present disclosure.

As depicted in FIG. 4A and FIG. 4B, in some embodiments, the controller 102 may be configured to use the fans 112, 114 and the inherent layout of the battery enclosure system 100 and baffles 120 to cause an induction of cold or warm air into certain areas, strategically. For example, during standby and normal operating temperature, first fans 112 may be configured to be idle, and second fans 114 may be configured to be activated (i.e., operated). For instance, the second fans 114 may be configured to be activated just fast enough to: 1) prevent warm air from entering rear through second side wall 132 (e.g., warm side); and to 2) induce a (token) amount of cool air over the battery cells 116, through orifices 150 (e.g., gaps between baffles 120 and internal walls of housing 110), decreasing temperature change (ΔT) from the battery cells 116 nearer the front (cool) side versus the batteries 116 nearer the rear (warm) side (e.g., second side wall 132). For example, the less than a 50% power/capacity of the fans may be used for such a token amount. Note that the batteries 116 may reject zero heat in this case. In embodiments, the air flow speed at the orifice 150 and the corresponding fan speeds for such an air flow speed may be configured to (e.g., tuned through testing or simulation) minimize battery cell temperature change from a front side to back side (e.g., from first side wall 130 to second side wall 132).

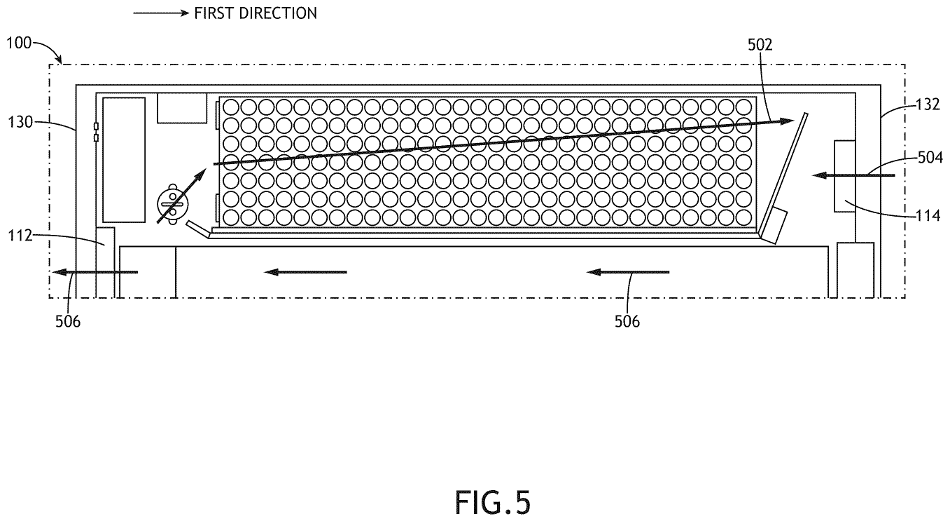

FIG. 5 illustrates a top view of the battery enclosure system 100 with side air flows toward the first direction and second fans directing air away from the first direction, as well as central air flow away from the first direction, in accordance with one or more embodiments of the present disclosure.

Note that the inherent layout of the battery enclosure system 100 of FIG. 4A is exactly the same as shown in FIG. 5, but that the air flow paths are in different areas and in different directions. This contrast illustrates how the baffles 120 may be used to provide a variety of air flow paths, even when the layout doesn't change, and without needing a separate set of fans aligned in the center and the sides to get control over those pathways selectively.

FIG. 5 illustrates an alternative scenario that the battery enclosure system 100 may be configured for.

During standby, the battery enclosure system 100 may be configured to keep the second fans 114 idle so high pressure warm air 504 naturally enters a rear of the housing 110. Further, the battery enclosure system 100 may be configured to control the first fans 112 to throttle a select amount of warm air 504 entering the housing 110, to maintain some circulation inside the housing 110, and to maintain pressure below the pressure of the hot aisle external to the second fans 114. The circulation may include a first air 506 over the corridor away from the first direction and a second air 502 over the batteries towards the first direction. In this way, warm air 504 from the rear may be used to circulate air inside the housing 110 to maintain the batteries at a threshold temperature. For example, the batteries may be maintained at higher than 15° C. using such a configuration. Such a configuration may be referred to as a circulation mode configured to circulate air 502, 506 within the housing 110 and thereby maintain the batteries 116 above a threshold temperature.

In embodiments, the battery enclosure system 100 may include one or more temperature sensors (not shown) strategically positioned within and outside the housing 110 to monitor thermal conditions across different regions and air flow paths. For example, a first temperature sensor may be disposed proximate to the first portion of the set of battery cells 116 near the first side wall 130, and a second temperature sensor may be disposed proximate to the second portion of the set of battery cells 116 near the second side wall 132. By way of another example, a third temperature sensor may be positioned within the corridor 140 adjacent to the converter 142 to monitor temperatures of components generating substantial heat. In some embodiments, additional temperature sensors may be located within the air flow paths between the one or more baffles 120 and outside the one or more baffles 120 to provide real-time feedback on air temperatures in the central path versus the side paths. The one or more temperature sensors may be coupled to the controller 102 and configured to provide temperature data to the one or more processors 106. The set of program instructions may be further configured to cause the one or more processors 106 to adjust the respective first fan speed and the respective second fan speed based on the temperature data to maintain the set of battery cells 116 within a desired temperature range (e.g., within 15-45° C.) and to minimize temperature differential between front and rear portions of the battery cells 116 to within approximately 3° C.

In embodiments, the controller 102 may be configured to implement a dynamic thermal management algorithm that is configured to automatically transition between operating modes based on monitored temperatures using the temperature sensors and/or any other data (e.g., battery discharging or charging data). For example, when temperature sensors indicate that the set of battery cells 116 are within a nominal operating range (e.g., between 20-35° C.) and a temperature differential between front and rear battery cells is less than 2° C., the controller 102 may be configured to operate in a standby mode with the one or more first fans 112 at idle and the one or more second fans 114 operating at less than 50% capacity to prevent warm air ingress. When the temperature differential exceeds 2° C. or when ambient cold aisle temperatures drop below 10° C., the controller 102 may be configured to switch to the circulation mode by reducing the second fan speed to idle and operating the first fans 112 less than 50% capacity to induce controlled warm air circulation from the hot aisle. During charging or discharging operations when the converter 142 generates heat exceeding a threshold (e.g., raising corridor temperature above 40° C.), the controller 102 may activate both the first fans 112 and second fans 114 at 50 to 100% capacity to provide active cooling along the central air path in the first direction.

The one or more processors 106 of controller 102 may include any one or more processing elements known in the art. In this sense, the one or more processors 106 may include any microprocessor device configured to execute algorithms and/or instructions. In one embodiment, the one or more processors 106 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium (e.g., memory 104). Moreover, different subsystems of the system 100 may include processor or logic elements suitable for carrying out at least a portion of the steps described throughout the present disclosure. Therefore, the above description should not be interpreted as a limitation on the present invention but merely an illustration.

The memory 104 may include any storage medium known in the art suitable for storing program instructions executable by the associated one or more processors 106. For example, the memory 104 may include a non-transitory memory medium. For instance, the memory 104 may include, but is not limited to, a read-only memory, a random access memory, a magnetic or optical memory device (e.g., disk), a magnetic tape, a solid state drive and the like. In another embodiment, it is noted herein that the memory 104 is configured to store one or more results from the system 100 and/or the output of the various steps described herein. It is further noted that memory 104 may be housed in a common controller housing with the one or more processors 106. In an alternative embodiment, the memory 104 may be located remotely with respect to the physical location of the processors and controller 102. For instance, the one or more processors 106 of controller 102 may access a remote memory (e.g., server), accessible through a network (e.g., internet, intranet and the like). In another embodiment, the memory 104 stores the program instructions for causing the one or more processors 106 to carry out the various steps described through the present disclosure.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

In another embodiment, the controller 102 of the system 100 may be configured to receive and/or acquire data or information from other systems by a transmission medium that may include wireline and/or wireless portions. In another embodiment, the controller 102 of the system 100 may be configured to transmit data or information (e.g., the output of one or more processes disclosed herein) to one or more systems or sub-systems by a transmission medium that may include wireline and/or wireless portions. In this manner, the transmission medium may serve as a data link between the controller 102 and other subsystems of the system 100. Moreover, the controller 102 may send data to external systems via a transmission medium (e.g., network connection).

In a general sense, those skilled in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

We claim:

1. A battery enclosure system comprising:
a housing configured to enclose a set of battery cells, wherein the housing comprises:
one or more baffles extending along a first direction, each baffle comprising a first section disposed along the first direction, and a second section coupled to the first section and angled from the first section by a baffle angle;
one or more first fans coupled to a first side wall of the housing;
one or more second fans coupled to a second side wall of the housing, wherein the second side wall is at an opposing end of the housing relative to the first side wall along the first direction;
the set of battery cells disposed along a floor of the housing; and
a controller including one or more processors coupled to the one or more first fans and the one or more second fans and configured to execute a set of program instructions stored in a memory, the set of program instructions configured to cause the one or more processors to:
selectively operate at least one of the one or more first fans or the one or more second fans at least one of a respective first fan speed or a respective second fan speed to selectively control air flow paths within the housing, wherein the air flow paths are disposed at least one of between the one or more baffles or outside the one or more baffles.

2. The battery enclosure system of claim 1, wherein the baffle angle is more than 10 degrees from the first direction and more than 90 degrees as measured as an arc from the first section.

3. The battery enclosure system of claim 1, wherein the one or more baffles comprise two opposing baffles with respective baffle angles angled away from a center of the housing.

4. The battery enclosure system of claim 1, wherein the housing comprises holes on a third side wall and fourth side wall of the housing orthogonal to the first side wall and the second side wall.

5. The battery enclosure system of claim 1, wherein the baffle angle and the second section of each baffle are adjustable.

6. The battery enclosure system of claim 1, wherein the one or more second fans are positioned in front of the second section of at least one baffle of the one or more baffles along the first direction and wherein the one or more first fans are placed along a central air path between two distinct baffles, wherein the one or more baffles comprises two or more baffles comprising the two distinct baffles.

7. The battery enclosure system of claim 1, wherein the battery enclosure system is configured for a circulation mode configured to circulate air within the housing and thereby maintain the set of battery cells above a threshold temperature.

8. The battery enclosure system of claim 1, further comprising a DC-DC converter disposed in a corridor between two of the one or more baffles, wherein the one or more first fans and the one or more second fans are configured to cool the DC-DC converter during charging and discharging of the set of battery cells.

9. The battery enclosure system of claim 8, wherein a first portion of the set of battery cells is located on a first side of the corridor and a second portion of the set of battery cells is located on a second side of the corridor opposite relative to the first side.

10. The battery enclosure system of claim 9,
wherein the set of battery cells and the DC-DC converter disposed inside a volume of the housing are shorter than an internal height of the volume inside the housing to allow air to flow over the set of battery cells and the DC-DC converter.

11. A method comprising:
selectively operating at least one of one or more first fans or one or more second fans at least one of a respective first fan speed or a respective second fan speed to selectively control air flow paths within a housing of a battery enclosure system, wherein the air flow paths are disposed at least one of: between one or more baffles; or outside the one or more baffles,
wherein the battery enclosure system comprises:
the housing enclosing a set of battery cells, wherein the housing comprises:
the one or more baffles extending along a first direction, each baffle comprising a first section disposed along the first direction, and a second section coupled to the first section and angled from the first section by a baffle angle;
the one or more first fans coupled to a first side wall of the housing;
the one or more second fans coupled to a second side wall of the housing, wherein the second side wall is at an opposing end of the housing relative to the first side wall along the first direction; and
the set of battery cells disposed along a floor of the housing.

12. The method of claim 11, wherein the baffle angle is more than 10 degrees from the first direction and more than 90 degrees as measured as an arc from the first section.

13. The method of claim 11, wherein the one or more baffles comprise two opposing baffles with respective baffle angles angled away from a center of the housing.

14. The method of claim 11, the housing further comprising holes on a third side wall and fourth side wall of the housing orthogonal to the first side wall and the second side wall.

15. The method of claim 11, further comprising adjusting the baffle angle and the second section of at least one baffle of the one or more baffles.

16. The method of claim 11, wherein the one or more second fans are positioned in front of the second section of the one or more baffles along the first direction and wherein the one or more first fans are placed along a central air path between two distinct baffles, wherein the one or more baffles comprises two or more baffles comprising the two distinct baffles.

17. The method of claim 11, wherein the battery enclosure system is configured for a circulation mode configured to circulate air within the housing and thereby maintain the set of battery cells above a threshold temperature.

18. The method of claim 11, further comprising a DC-DC converter disposed in a corridor between two of the one or more baffles, wherein the one or more first fans and the one or more second fans are configured to cool the DC-DC converter during charging and discharging of the set of battery cells.

19. The method of claim 18, wherein a first portion of the set of battery cells is located on a first side of the corridor and a second portion of the set of battery cells is located on a second side of the corridor opposite relative to the first side.

20. The method of claim 19,
wherein the set of battery cells and the DC-DC converter disposed inside a volume of the housing are shorter than an internal height of the volume inside the housing to allow air to flow over the set of battery cells and the DC-DC converter.
